(19) United States
(12) Patent Application Publication
(10) Pub. No.: US 2012/0267886 A1
(43) Pub. Date: Oct. 25, 2012

(54) Academic Planner

(75) Inventor: Soon Hoo Kwon, Seoul (KR)

(73) Assignee: RealSAT co.,ltd, Seoul (KR)

(21) Appl. No.: 13/450,859

(22) Filed: Apr. 19, 2012

(30) Foreign Application Priority Data
Apr. 19, 2011 (KR) 10-2011-0036318

(51) Int. Cl. B42D 5/04

(52) U.S. Cl. 283/2

(57) ABSTRACT

An academic planner, with which a student who is preparing for college admission in the United States can prepare a variety of factors, such as academic achievement, extracurricular activities, personal life, and the like, which are used as criteria for the evaluation of candidates for college admission. The academic planner includes a cover, a number of inner sheets, a course schedule section formed on an inner side of the cover, monthly schedule sections formed on the inner sheets, the monthly schedule sections being intended for use in writing therein monthly schedules, weekly schedule sections formed on the inner sheets after the monthly schedule sections, the weekly schedule sections being intended for use in writing therein weekly schedules, and daily schedule sections formed on the inner sheets after the weekly schedule sections.

### CROSS REFERENCE TO RELATED APPLICATION

The present application claims the benefit of Korean Patent Application Number 10-2011-0036318 filed on Apr. 19, 2011, the entire teachings and disclosure of which application are incorporated herein for all purposes by this reference.

### BACKGROUND OF THE INVENTION

1. Field of the Invention

The present invention relates to an academic planner, with which a student who is preparing for college admission in the United States can prepare a variety of factors, such as academic achievement, extracurricular activities, personal life, and the like, which are used as criteria for the evaluation of candidates for college admission.

2. Description of Related Art

The Scholastic Assessment Test (SAT) is an admission qualification test that any student who applies to a college in the United States must take. The result of the SAT is taken into account in the examination of the entrance requirements when a candidate applies to a college in the United States. The SAT is offered 7 times a year, on the same date in the world. The SAT is divided into the “SAT reasoning test” and the “SAT subject test.”

The SAT reasoning test consists of three sections, including reading, mathematics and writing. The SAT subject test is selected from a total of 20 standardized tests, encompassing mathematics, biology, chemistry, English literature, physics, world history, US history, foreign languages, and so on.

In each individual section or test, the highest score is 800 and the lowest score is 200. ¼ point is deducted when a candidate gets a question wrong. This test is offered a total of 7 times a year, and test takers are individually informed of scores.

In order to enter a college in the United States, in addition to the preparation for the qualification test, such as the SAT, the evaluation of extracurricular activities is regarded as an important factor. Furthermore, a balanced personal life is also regarded as an important factor in the evaluation.

For candidates who must prepare for several factors, such as academic achievement, extracurricular activities, and public services, for college admission, there has been no specific measure with which they can plan and check several activities by themselves. In most cases, candidates prepare for admission by making plans by writing notes in a variety of traditional diaries, and fulfilling the plans.

In such cases, it is possible to check quantitative activities by recording them in numbers in a typical diary. However, it is very difficult to systematically, specifically and continuously manage personal activities (academic achievement, extracurricular activities, public service, and special activities), which are necessary for college admission, while achieving balance among academic achievement, extracurricular activities, public services, and special activities.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide an academic planner, with which a student who is preparing for college admission in the United States can make balanced plans among various activities and systematically record and utilize activities that he/she executed.

Also provided is an academic planner, with which a student who is preparing for college admission can systematically manage schedules in monthly, weekly, and daily bases in a balanced way, and at the same time, manage schedules based on time.

In an aspect of the present invention, provided is an academic planner that includes a cover and a number of inner sheets. The academic planner also includes a course schedule section formed on an inner side of the cover, the course schedule section being intended for use in writing therein class schedules, which are repeated on a weekly basis; monthly schedule sections formed on the inner sheets, the monthly schedule sections being intended for use in writing therein monthly schedules, including important dates related to college admission; weekly schedule sections formed on the inner sheets after the monthly schedule sections, a group of the weekly schedule sections belonging to a respective month being sequentially arranged and divided on a weekly basis, the weekly schedule sections being intended for use in writing therein weekly schedules; and daily schedule sections formed on the inner sheets after the weekly schedule sections, a group of the daily schedule sections belonging to a respective month being sequentially arranged on a daily basis. Each of the daily schedule sections includes a day schedule section positioned in a left part of a corresponding one of the inner sheets, the day schedule section being stretched in the vertical direction and divided based on time; an academic achievement section arranged to the right of the day schedule section; an extracurricular activities section arranged under the academic achievement section, the size of the extracurricular activities section being equal to that of the academic achievement section; and a personal life section arranged under the extracurricular activities section.

In an exemplary embodiment, the academic planner may further include weekly information sections arranged on same inner sheets as the weekly schedule sections. Each of the weekly information sections is positioned under a corresponding one of the weekly information sections, and provides important schedules and information related to college admission by dividing the important schedules and information related to college admission based on level.

In an exemplary embodiment, the academic planner may further include daily information sections each arranged under a corresponding one of the day schedule sections and a corresponding one of the personal life sections. The daily information section provides important information and schedules of a corresponding date by marking the important information and schedules depending on types of the information.

In an exemplary embodiment, the monthly schedule sections, the weekly schedule sections and the daily schedule sections repeat on a monthly basis.

In an exemplary embodiment, the academic planner may further include a guide section, which contains pieces of information on main tests related to college admission, including information on test months, basic information, information on reference books, and information on activities, in one section, and a strategic test schedule section, which includes a list of subjects for which a user is to take an examination before the user applies to a college, and an annual test schedule.

In an exemplary embodiment, each of the academic schedule section, the extracurricular activities section and the personal life section may include a priority section, in which priority is to be written, and a result section, in which a progress is to be written.

With the academic planner according to embodiments of the present invention, a student who is preparing for college admission in the United States can make balanced plans among various activities and systematically record and utilize activities that he/she executed.

In addition, a student who is preparing for college admission can systematically manage schedules in monthly, weekly, and daily bases in a balanced way, and at the same time, manage schedules based on time.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a view showing a course schedule section of an academic planner according to an exemplary embodiment of the invention;

FIG. 2 is a view showing a monthly schedule section of the academic planner according to an exemplary embodiment of the invention;

FIG. 3 is a view showing a weekly schedule section of the academic planner according to an exemplary embodiment of the invention;

FIG. 4 is a view showing a daily schedule section of the academic planner according to an exemplary embodiment of the invention;

FIG. 5 is a view showing a guide section of the academic planner according to an exemplary embodiment of the invention; and

FIG. 6 is a view showing a strategic test schedule section of the academic planner according to an exemplary embodiment of the invention.

### DETAILED DESCRIPTION OF THE INVENTION

Reference will now be made in detail to various embodiments of the present invention, examples of which are illustrated in the accompanying drawings and described below. While the invention will be described in conjunction with exemplary embodiments thereof, it is to be understood that the present description is not intended to limit the invention to those exemplary embodiments. On the contrary, the invention is intended to cover not only the exemplary embodiments, but also various alternatives, modifications, equivalents and other embodiments that may be included within the spirit and scope of the invention as defined by the appended claims.

The present invention provides an academic schedule planner, with which students who are preparing for college admission in the United States can make balanced preparations and arrangements among various factors that are necessary for college admission. For this purpose, the academic planner according to an exemplary embodiment of the present invention basically includes the following sections, namely, course, monthly, weekly and daily schedule sections.

Course Schedule Section

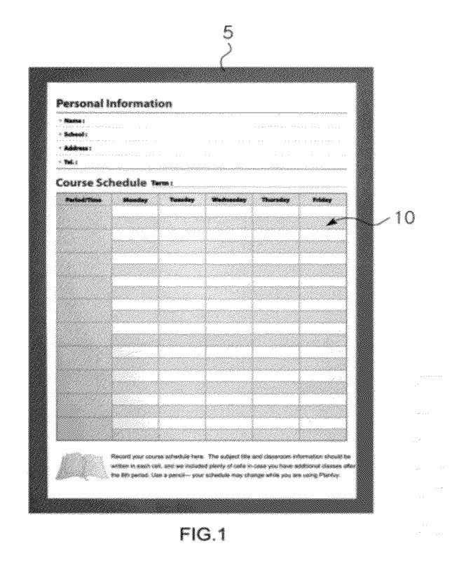

FIG. 1 shows the course schedule section 10 of the academic planner according to an exemplary embodiment of the invention. The course schedule section 10 is intended for use in writing class schedules, which are repeated on a weekly basis, therein. The course schedule section 10 has the shape of a table that is divided into a plurality of blocks. In the course schedule section 10, weekday sections and time sections are arranged on the X and Y axes, respectively.

The course schedule section 10 is provided on the inner side 5 of a cover of the planner. It is preferred that the course schedule section 10 be positioned in the front part of the planner in consideration of the construction of the planner. The planner includes a pair of covers and a number of inner sheets of paper, which are provided inside the pair of covers. The covers are generally made of a rigid material such that they are not easily bent.

Therefore, the course schedule section 10 is provided on the inner side of the cover of the planer so as to be easily distinguished from the other inner sheets, and to help a user easily check schedule items that repeat on a weekly basis.

Monthly Schedule Section

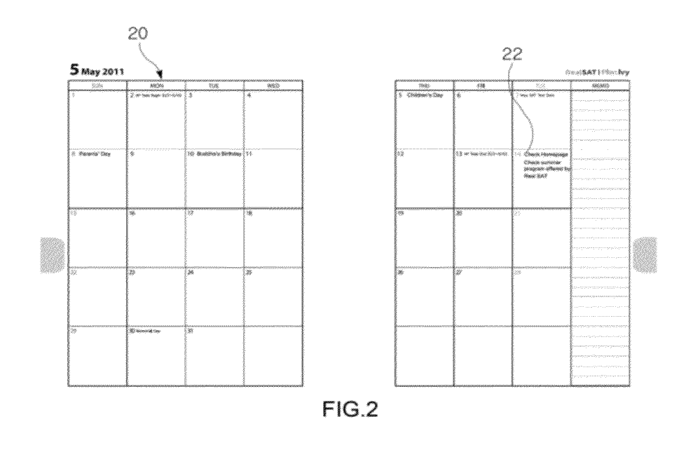

FIG. 2 shows the monthly schedule section 20 of the academic planner according to an exemplary embodiment of the invention. The monthly schedule section 20 has an arrangement that is basically similar to that of the monthly schedule section of a traditional diary.

That is, the blocks of the monthly schedule section 20 are partitioned using a pair of inner sheets on the left and right such that all of the days in one month can be viewed in a plane that is spread. Dates of the month are recorded in blocks that are partitioned in this way.

The monthly schedule section of the invention is characterized in that important dates related to college admission are recorded in advance. Monthly important dates 22 are recorded in blocks corresponding to particular dates in advance, and categories and important contents depending on the important dates are recorded.

Weekly Schedule Section

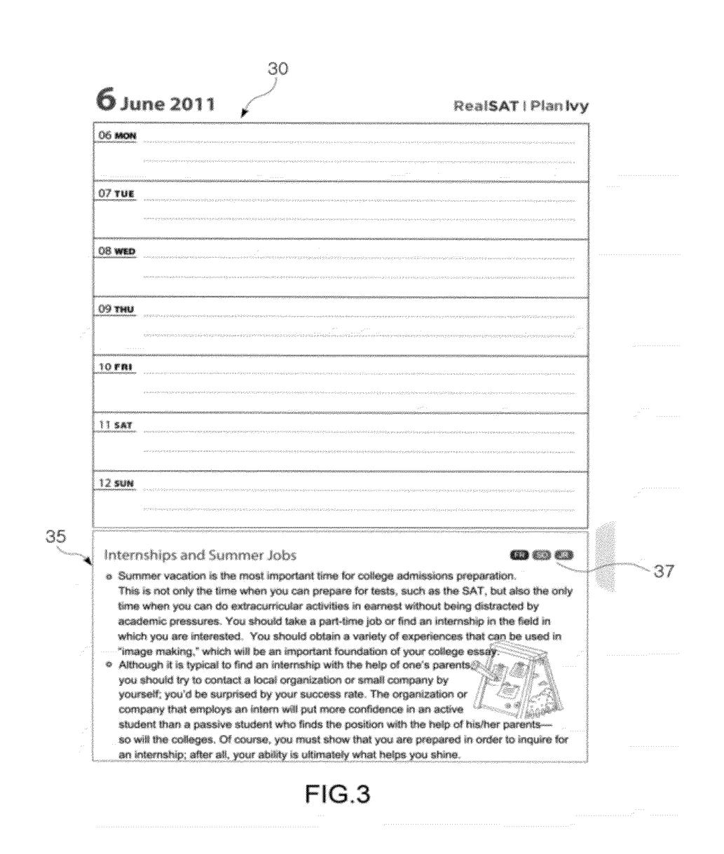

FIG. 3 shows the weekly schedule section 30 of the academic planner according to an exemplary embodiment of the invention. The weekly schedule section 30 is positioned after the monthly schedule section 20.

In particular, the weekly schedule section is arranged after the monthly schedule section of the corresponding month. The items in the schedule are sequentially arranged on a weekly basis. FIG. 3 shows one week of July, in which the weekdays of one week are divided and partitioned from each other in the shape of a table, such that items can be recorded for particular weekdays.

A weekly information section 35 is disposed at the bottom of the weekly schedule section 30. The weekly information section 35 is formed on the same inner sheet as the weekly schedule section 30, and provides important schedules and information related to college admission for a particular state in the United States.

In particular, a level-based index 37 is formed such that the provided information can be displayed depending on the level or the academic year of the user. In this way, the monthly important dates 22 and the weekly information section enable the user to check important dates in the corresponding month or week, rather than missing them.

In addition, appropriate timely advice may be recorded in the weekly information section.

That is, advice related to GPA/school classes, the SAT, the AP test, and the TOEFL, advice related to extracurricular activities, advice related to college applications, advice on school life, etc. may be recorded.

Daily Schedule Section

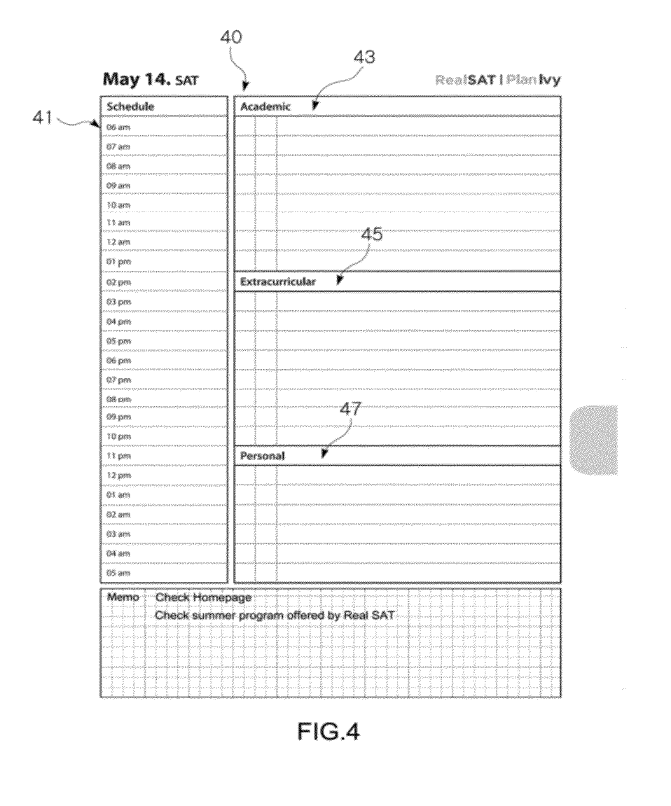

FIG. 4 shows the daily schedule section 40 of the academic planner according to an exemplary embodiment of the invention. The daily schedule section 40 includes a schedule section 41, an academic achievement section 43, an extracurricular activities section 45, and a personal life section 47.

A predetermined daily schedule section 40 is arranged as separate inner sheets on a daily basis after the weekly schedule section 30.

Therefore, the items for one month are recorded on the monthly schedule section page, the weekly schedule section pages, and the daily schedule section pages. This arrangement is repeated in every month.

The schedule section 41 of the daily schedule section 40 is positioned in the left part of an inner sheet, and is stretched in the vertical direction, which is divided based on time.

The schedule section 41 is constructed such that items for a corresponding date are recorded thereon based on time.

The academic achievement section 43, the extracurricular activities section 45, and the personal life section 47 are arranged to the right of the schedule section 41. In this way, the daily schedule is divided into three sections corresponding to the three fields in order to help the user plan daily activities so as to satisfy the three categories of standards for college admission in the United States.

The academic achievement section 43 is partitioned such that schedules for the GPA, the SAT, and the like, which are the most important factors in the evaluation of candidates for college admission, are recorded therein. College admission in the United States requires the completion of specific courses of study, including 4 years of English courses, 4 years of mathematics courses, 3 or 4 years of second language courses, 3 years of empirical science courses, 3 years of social science courses (including history), and the like.

However, the curriculum of a high school that a user is attending may not satisfy the foregoing conditions, and the field in which a student is interested may differ from others. Therefore, it should also be considered that the requirements are not fulfilled 100% in some cases.

Although it is not seriously problematic when completed classes are slightly unbalanced, it is preferable for a student to attend classes such that the curriculum is balanced and to achieve high scores. Therefore, it is required to properly select classes and make up a time plan for academic achievement in order to satisfy the condition of “highest-level classes that can be attended.”

The extracurricular activities section 45 is positioned below the academic achievement section 43. The extracurricular activities section 45 is partitioned such that the plans and records of various activities related to school life other than academic achievement are written therein.

Extracurricular activities refer to various activities, for example, soccer, tennis, orchestra, mathematics club, and school papers. These activities become the foundation that forms the image of a candidate for college admission.

In the academic planner according to an exemplary embodiment of the invention, one of the major characteristics is that the user can systematically manage extracurricular activities through the extracurricular activities section so that he/she can utilize all of his/her activities in the portfolio when applying for college. This is also helpful in editing the essay that is required for college admission.

The personal life section 47 is positioned below the extracurricular activities section 45. The personal life section 47 can be an important factor for college admission under the admission officer system, which is operated by colleges in the United States.

“Personal life” refers to personal interests, skills developed in one's spare time, and particulars of personal life that are distinguished from extracurricular activities at school. This planner guides the user to separately write and manage his/her personal life by distinguishing the personal life section from the other sections, so that the user can lead a balanced life and properly prepare for college admission.

In addition, a daily information section 49 is formed under the personal life section 47 and the schedule section 41. The daily information section 49 provides important schedules and information about a corresponding date. Particularly, the daily information section 49 provides important information about the corresponding date related to college admission, the information being marked depending on the information types.

Supplement

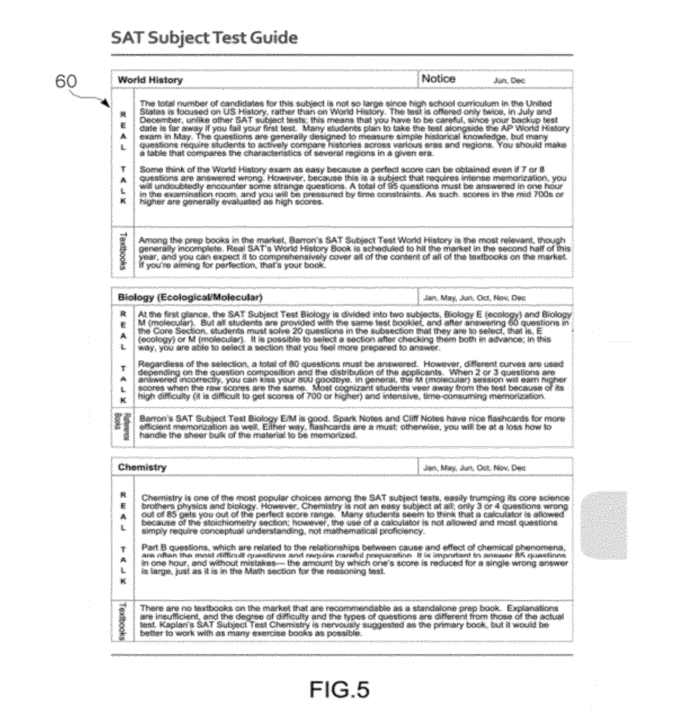

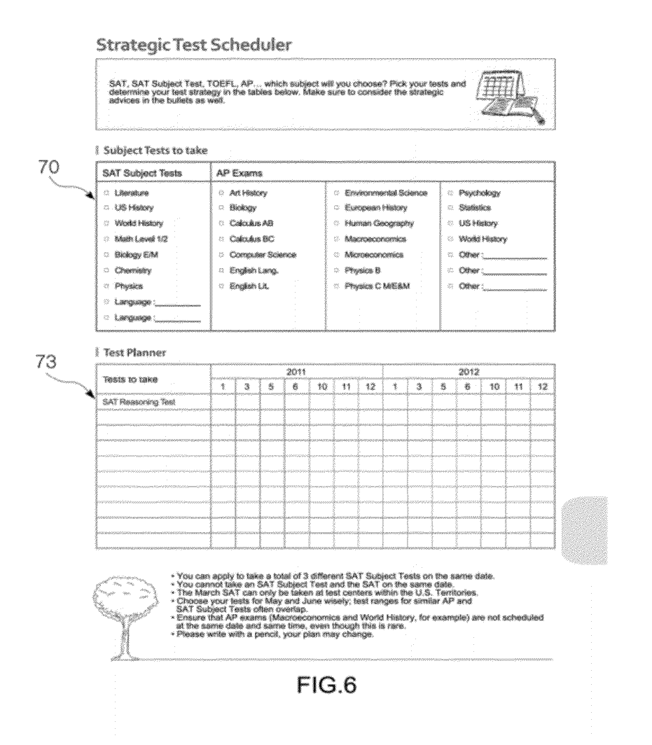

FIG. 5 shows the guide section 60 of the academic planner according to an exemplary embodiment of the invention, and FIG. 6 shows the strategic test schedule section 70 of the academic planner according to an exemplary embodiment of the invention.

The guide section 60 and the strategic test schedule section 70 are positioned in the rear part of the planner according to an exemplary embodiment of the invention. Preferably, they are positioned as the last section.

The guide section 60 includes some pieces of information on main tests related to college admission (e.g. the SAT), such as information on test months, basic information, information on reference books, and information on activities, in one section.

The strategic test schedule section 70 provides a list of subjects for which the user will take an examination before he/she applies to a college.

An annual test schedule 73 is provided under the table, such that information on tests that will be strategically taken can be managed.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An academic planner, comprising:
a cover;
a number of inner sheets;
a course schedule section formed on an inner side of the cover, the course schedule section being intended for use in writing therein class schedules, which are repeated on a weekly basis;
monthly schedule sections formed on the inner sheets, the monthly schedule sections being intended for use in writing therein monthly schedules, including important dates related to college admission;
weekly schedule sections formed on the inner sheets after the monthly schedule sections, a group of the weekly schedule sections belonging to a respective month being sequentially arranged and divided on a weekly basis, the weekly schedule sections being intended for use in writing therein weekly schedules;
daily schedule sections formed on the inner sheets after the weekly schedule sections, a group of the daily schedule sections belonging to a respective month being sequentially arranged on a daily basis, wherein each of the daily schedule sections comprises:
a day schedule section positioned in a left part of a corresponding one of the inner sheets, the day schedule section being stretched in a vertical direction and divided based on time;
an academic achievement section arranged to a right of the day schedule section, the academic achievement section being intended for use in writing therein schedules for GPA and SAT, which are most important factors in evaluation of candidates for college admission;
an extracurricular activities section arranged under the academic achievement section, a size of the extracurricular activities section being equal to that of the academic achievement section, the extracurricular activities section being intended for use in writing therein various activities related to school life other than academic achievement, wherein all of the various activities can be utilized in a portfolio when a user applies for college in the United States, and are helpful in editing an essay that is required for college admission in the United States; and
a personal life section arranged under the extracurricular activities section, the personal life section being intended for use in writing therein personal interests, skills developed in one's spare time, and particulars of personal life that are distinguished from extracurricular activities at school,
a guide section, which contains pieces of information on main tests related to college admission, including information on test months, basic information, information on reference books, and information on activities, in one section;
a strategic test schedule section, which includes a list of subjects for which a user is to take an examination before the user applies to a college in the United States, and an annual test schedule about main tests related to college admission in the United States;
weekly information sections arranged on same inner sheets as the weekly schedule sections, each of the weekly information sections being positioned under a corresponding one of the weekly information sections, and providing important schedules and information related to college admission in the United States by dividing the important schedules and information related to college admission based on level; and
daily information sections each arranged under a corresponding one of the day schedule sections and a corresponding one of the personal life sections, the daily information section providing important information and schedules of a corresponding date by marking the important information and schedules depending on types of the information.

2. The academic planner of claim 1, wherein the monthly schedule sections, the weekly schedule sections and the daily schedule sections are arranged so as to repeat on a monthly basis.
